(19) United States
(12) Patent Application Publication
(10) Pub. No.: US 2025/0141359 A1
(43) Pub. Date: May 1, 2025

(54) Power controller, switch-mode power supply, and control method thereof

(71) Applicant: ARK MICROELECTRONIC CORP. LTD., Shenzhen (CN)

(72) Inventors: Yi-Lun Shen, Taipei City (TW); Yu-Yun Huang, Taipei City (TW)

(73) Assignee: ARK MICROELECTRONIC CORP. LTD., Shenzhen (CN)

(21) Appl. No.: 18/926,333

(22) Filed: Oct. 25, 2024

(30) Foreign Application Priority Data
Nov. 1, 2023 (CN) 202311439703.X

(51) Int. Cl. H02M 3/335; H02M 1/00; H02M 1/36; H02M 3/00

(52) U.S. Cl. CPC H02M 3/33571; H02M 1/0019; H02M 1/36; H02M 3/01; H02M 3/33592

(57) ABSTRACT

A switch-mode power supply is used to provide an output voltage and includes an inductor and a power switch, where the power switch is used to control the current flowing through the inductor. A control method for the switch-mode power supply includes: providing a compensation signal controlled by the output voltage; providing a stable compensation signal for the low-frequency component of the compensation signal based on the compensation signal; providing a mixed operation mode, in which the switch-mode power supply alternately operates during a switching operation period and an skip period, the power switch opens at least once during the switching operation period, and the power switch is closed during the skip period; based on the difference between the compensation signal and the stable compensation signal, ending one of the switching operation period and skip period, and starting another one of the switching operation period and skip period.

### BACKGROUND OF THE INVENTION

### 1. Field of the Invention

The present invention relates to the field of electronic technology, and more particularly to a power controller, a switch-mode power supply, and a control method.

### 2. Description of the Prior Art

A power supply is used to convert an input voltage into one or more output voltages, serving as the input voltage for electronic products. With the widespread use of portable electronic products, power supplies are also required to have high power, high efficiency, and small size.

An asymmetric half-bridge (AHB) power supply is a type of switch-mode power supply with a simple structure that can provide more than 100 W of power. This power supply has high-side and low-side switches on the primary side of the transformer, configured in a half-bridge structure, and provides different pulse width modulation (PWM) signals for these switches, hence the term “asymmetric.” The transformer in the AHB power supply is also connected to an oscillating capacitor on the primary side to form a resonance circuit.

When the load powered by the AHB power supply is heavy, the high-side and low-side switches are generally complementary during a switching cycle. The resonance circuit undergoes charging and discharging and resonates, allowing the switches to achieve zero voltage switching (ZVS) with low switching loss, resulting in superior conversion efficiency.

When the load is medium or light, one method to reduce switching loss is to increase the switching cycle, i.e., reduce the switching frequency. However, as the switching cycle of the AHB power supply increases, maintaining ZVS for the switches becomes a technical challenge.

China Patent Publication No. CN111010036A teaches a technique where, under light load, in a switching cycle of a Discontinuous Conduction Mode (DCM), the low-side switch of the AHB power supply is turned on only once (for a period of time), while the high-side switch is turned on twice: once after the low-side switch is turned on, and once before the low-side switch is turned on in the next switching cycle.

China Patent Publication No. CN104779806 teaches another technique where, in a switching cycle, the low-side switch of the AHB power supply is turned on only once, and the high-side switch is also turned on only once. When the load is heavy, the high-side switch is turned on approximately immediately after the low-side switch is turned off, making the switches generally complementary; when the load is light, the switching cycle is extended. After the low-side switch is turned off, the high-side switch is not turned on immediately but waits until the end of the current switching cycle. In other words, the high-side switch is turned on approximately before the start of the next switching cycle.

### SUMMARY OF THE INVENTION

According to one aspect of the embodiments of the present invention, a control method for a switch-mode power supply is provided. The switch-mode power supply is used to provide an output voltage and comprises an inductor and a power switch. The power switch is used to control the current flowing through the inductor. The control method comprises: providing a compensation signal, the compensation signal being controlled by the output voltage; providing a stable compensation signal based on the compensation signal, the stable compensation signal being the low-frequency component of the compensation signal; providing a mixed operation mode, in which the switch-mode power supply alternates between a switching operation period and an skip period, wherein during the switching operation period, the power switch is turned on at least once, and during the skip period, the power switch remains off; and ending one of the switching operation period and the skip period and starting the other based on the difference between the compensation signal and the stable compensation signal.

According to another aspect of the embodiments of the present invention, a power controller suitable for a switch-mode power supply is provided. The switch-mode power supply is used to provide an output voltage and comprises an inductor and a power switch. The power switch is used to control the current flowing through the inductor. In a mixed operation mode, the switch-mode power supply alternates between a switching operation period and an skip period, wherein during the switching operation period, the power switch is turned on at least once, and during the skip period, the power switch remains off. The power controller comprises: a signal generator, used to provide a stable compensation signal based on a compensation signal, wherein the compensation signal is controlled by the output voltage, and the stable compensation signal is the low-frequency component of the compensation signal; and a skip time generator, used to end one of the switching operation period and the skip period and start the other based on the difference between the compensation signal and the stable compensation signal.

According to yet another aspect of the embodiments of the present invention, a switch-mode power supply is provided, comprising the power controller as described in any of the above embodiments.

In the embodiments of the present invention, a mixed operation mode suitable for a medium load is provided. In the mixed operation mode, the switch-mode power supply alternates between a switching operation period and an skip period, wherein during the switching operation period, the power switch is turned on at least once, and during the skip period, the power switch remains off. By comparing the compensation signal controlled by the output voltage and the stable compensation signal, which is the low-frequency component of the compensation signal, the ending and starting of the switching operation period and the skip period are determined. Thus, since the difference between the compensation signal and the stable compensation signal can more accurately reflect the transient changes in the output voltage, when the load suddenly changes causing the output voltage to change, the ending and starting of the switching operation period and the skip period can be adjusted in a timely manner based on the difference between the compensation signal and the stable compensation signal, making the changes in the output voltage smoother (i.e., reducing the ripple of the output voltage), thereby effectively reducing the possible sudden changes in the output voltage during the process of the load changing from medium to heavy or from medium to light, and thus reducing the damage to the load.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an AHB power supply according to an embodiment of the present invention.

FIG. 2 shows some signal waveforms of the AHB power supply in FIG. 1 operating in CRM.

FIG. 3 shows signal waveforms of the AHB power supply according to an embodiment of the present invention operating in a mixed operation mode.

FIG. 4 shows an AHB controller according to an embodiment of the present invention.

FIG. 5 shows the relationship between the on-time T_{ON_GL} of the low-side switch and the compensation signal V_{COMP}, the maximum number N_{MAX} and the compensation signal V_{COMP}, and the skip time T_{SKIP} and the compensation signal V_{COMP}.

FIG. 6 shows another AHB controller according to an embodiment of the present invention.

FIG. 7 shows some signal waveforms of the AHB controller in FIG. 6 operating in a mixed operation mode.

FIG. 8 shows some signal waveforms generated by the AHB controller in FIG. 6 operating in different modes with different stable compensation signals V_{COMP-DC}.

FIG. 9 shows the signal converter 121, ZVS reference bit recorder 210, high-side controller 128C, and low-side controller 120C used in the AHB controller in FIG. 6.

FIG. 10A shows the switching cycle TCYC_{X} without debounce time T_{DEB}.

FIG. 10B shows the switching cycles TCYC_{Y1} and TCYC_{Y2} with debounce time T_{DEB}.

FIG. 11 shows the relationship between the debounce time T_{DEB} and the stable compensation signal V_{COMP-DC}.

FIG. 12 shows the high-side controller 128D and low-side controller 120D used in FIG. 9.

FIG. 13 shows the switching cycle TCYC_{Z} generated by the AHB power supply 100 under the control of the high-side controller 128D and low-side controller 120D in FIG. 12.

FIG. 14 shows the relationship between the delay time T_{DL} and the stable compensation signal V_{COMP-DC} in FIG. 12.

### DETAILED DESCRIPTION

The various exemplary embodiments of the present invention will now be described in detail with reference to the drawings. The description of the exemplary embodiments is merely illustrative and should not be construed as limiting the invention and its applications or uses. The invention can be implemented in many different forms and is not limited to the embodiments described herein. These embodiments are provided to make the invention thorough and complete, and to fully convey the scope of the invention to those skilled in the art. It should be noted that, unless otherwise specified, the relative arrangement of components and steps, the composition of materials, numerical expressions, and numerical values set forth in these embodiments should be interpreted as illustrative only and not as limiting. Furthermore, it should be understood that the dimensions of various parts shown in the drawings are not necessarily drawn to scale. Additionally, like or similar reference numerals denote like or similar components.

The terms “first,” “second,” and similar terms used in the present invention do not denote any order, quantity, or importance, but are merely used to distinguish different parts. Terms such as “including” or “comprising” mean that the elements preceding the term encompass the elements listed after the term, and do not exclude the possibility of including other elements. Terms such as “upper,” “lower,” etc., are used only to indicate relative positional relationships, and when the absolute position of the described object changes, the relative positional relationships may also change accordingly.

In the present invention, when a specific component is described as being located between a first component and a second component, there may or may not be an intervening component between the specific component and the first or second component. When a specific component is described as being connected to another component, the specific component may be directly connected to the other component without an intervening component, or it may be indirectly connected to the other component with an intervening component.

All terms (including technical and scientific terms) used in the present invention have the same meaning as commonly understood by one of ordinary skill in the art to which this invention belongs, unless otherwise specifically defined. It should also be understood that terms defined in commonly used dictionaries should be interpreted as having a meaning consistent with their meaning in the context of the relevant art, and should not be interpreted in an idealized or overly formal sense unless expressly so defined herein.

Techniques, methods, and devices known to those of ordinary skill in the relevant art may not be discussed in detail, but where appropriate, the techniques, methods, and devices should be considered part of the specification.

In this specification, some identical symbols represent elements with the same or similar structure, function, or principle, and those with general knowledge in the industry can infer based on the teachings of this specification. For the sake of brevity, elements with the same symbols will not be redundantly described.

Power supplies generally have three operating modes: continuous-conduction mode (CCM), critical mode (CRM), and discontinuous-conduction mode (DCM). In a switch-mode power supply, an inductor, which may be an inductor or a transformer, is used for energy storage and conversion. At the end of a switching cycle, CCM refers to the condition where the magnetizing current in the inductor does not return to zero before the next switching cycle begins.

Conversely, DCM refers to the condition where the magnetizing current remains approximately zero for a period of time before the next switching cycle begins. CRM can be considered a special case between CCM and DCM, where the next switching cycle begins shortly after the magnetizing current reaches zero.

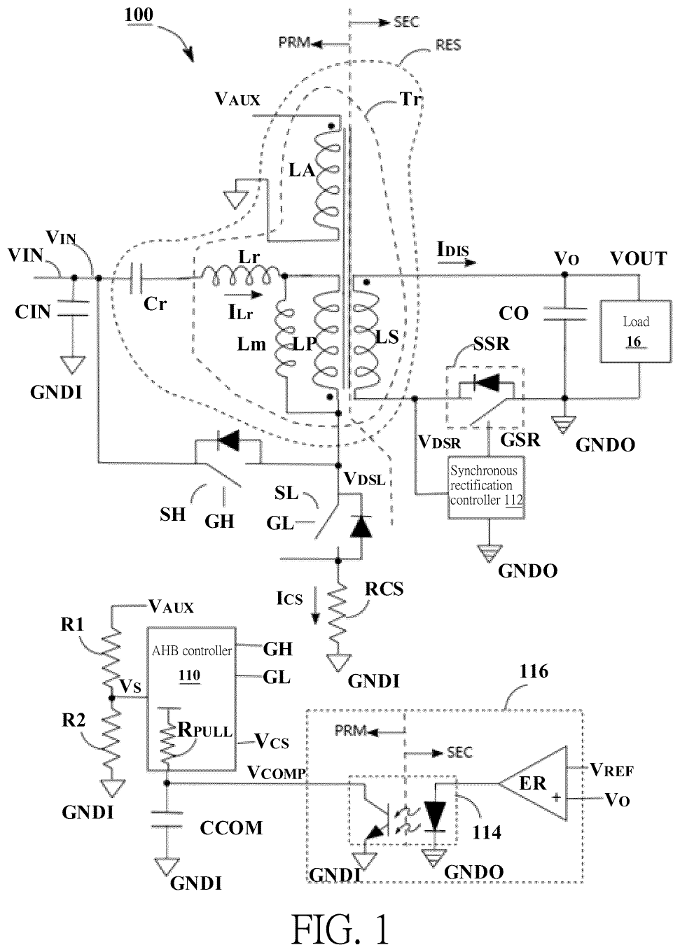

FIG. 1 shows an AHB power supply 100 implemented according to the present invention. On the primary side (PRM), the input capacitor CIN provides the input voltage V_{IN}, across the input voltage line VIN and the input ground line GNDI. The transformer Tr and the oscillating capacitor Cr can form a resonant circuit RES, connected to the upper arm switch SH and the lower arm switch SL. The upper arm switch SH and the lower arm switch SL form a half-bridge, connected in series between the input voltage line VIN and the input ground line GNDI, controlling the resonant circuit RES. There is a current detection resistor RCS between the lower arm switch SL and the input ground line GNDI, which can be used to detect the leakage current I_{Lr} flowing through the series leakage inductance Lr when the lower arm switch SL is turned on. The transformer Tr has a primary winding LP, a secondary winding LS, and an auxiliary winding LA, which are inductively coupled to each other. In FIG. 1, the series leakage inductance Lr and the parallel leakage inductance Lm respectively represent the inductances in series and parallel with the primary winding LP, and are not inductively coupled with other windings. The series leakage inductance Lr and the parallel leakage inductance Lm can be separate electronic components or parasitic inductances in the transformer Tr. The primary winding LP is electrically connected to the oscillating capacitor Cr. Based on the winding voltage V_{AUX}, the series resistors R1 and R2 provide a detection signal V_{S} to the AHB controller 110. Through the detection signal V_{S}, the AHB controller 110 detects the winding voltage V_{AUX} of the auxiliary winding LA and provides control signals GH and GL to control the upper arm switch SH and the lower arm switch SL, respectively. The synchronous rectification switch SSR on the secondary side (SEC) is connected between the secondary winding LS and the output capacitor CO, controlled by the synchronous rectification controller 112. In one embodiment, the synchronous rectification controller 112 and the synchronous rectification switch SSR can be replaced by a rectifier diode. The AHB controller 110 controls the switching of the upper arm switch SH and the lower arm switch SL, so that the resonant circuit RES draws energy from the input voltage V_{IN}. The synchronous rectification controller 112 performs the rectification function, allowing the transformer Tr to charge the output capacitor CO, establishing the output voltage V_{O} across the output voltage line VOUT and the output ground line GNDO, and supplying power to the load 16.

In this embodiment, the lower arm switch SL can be regarded as a charging switch because when the lower arm switch SL is turned on, the input voltage V_{IN} charges the transformer Tr and/or the oscillating capacitor Cr; the upper arm switch SH can be regarded as a resonant switch because when the upper arm switch SH is turned on, the resonant circuit RES starts to resonate.

The AHB power supply 100 shown in FIG. 1 is merely an example of an AHB power supply and is not intended to limit the present invention. For example, in another AHB power supply implemented according to the present invention, the resonant circuit RES is connected between the junction of the upper and lower arm switches SH and SL and the input ground line GNDI. In this case, the upper arm switch SH is a charging switch, and the lower arm switch SL is a resonant switch. In another embodiment, the series order of the primary winding LP and the oscillating capacitor Cr in the resonant circuit RES can be reversed.

The input voltage V_{IN} may be an output voltage provided by a previous stage PFC power converter, or an output voltage of a mains rectified by a bridge rectifier.

As shown in FIG. 1, the feedback circuit 116 detects the output voltage V_{O} of the secondary side SEC and provides a signal to the primary side PRM. The output voltage V_{O} is regulated through the feedback control provided by the optocoupler 114 to control the energy drawn by the primary side PRM from the input voltage V_{IN}, thereby stabilizing the output voltage V_{O}. The error amplifier ER on the secondary side SEC compares the output voltage V_{O} with the reference voltage V_{REF} and drives the optocoupler 114 to control the compensation signal V_{COMP} on the compensation capacitor CCOM located on the primary side PRM. FIG. 1 illustrates that the AHB controller 110 includes a pull-up resistor R_{PULL} connected between the high voltage power supply and the compensation capacitor CCOM. In FIG. 1, when the output voltage V_{O} is greater than the reference voltage V_{REF}, the error amplifier ER outputs a higher potential, causing the diode in the optocoupler 114 to emit stronger light, increasing the current flowing to the input ground line GNDI. The compensation signal V_{COMP} decreases over time, causing the resonant circuit RES to draw less energy from the input voltage V_{IN}, resulting in the transformer Tr charging the output capacitor CO less, thereby reducing the output voltage V_{O} and bringing it closer to the reference voltage V_{REF}. This stabilizes the output voltage V_{O} approximately at the reference voltage V_{REF}. From another perspective, the compensation signal V_{COMP} in FIG. 1 roughly corresponds to the load 16. When the output voltage V_{O} is maintained at the reference voltage V_{REF}, the greater the power required by the load 16 (the heavier the load 16, the higher the current drawn), the higher the compensation signal V_{COMP}.

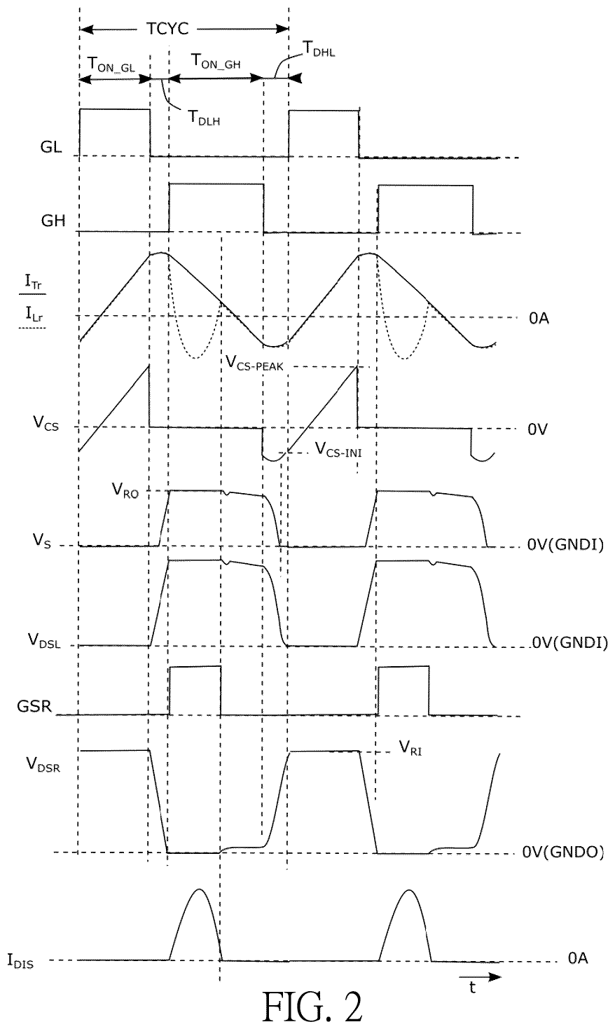

FIG. 2 shows some signal waveforms of the AHB power supply 100 in FIG. 1 when operating in CRM. From top to bottom, FIG. 2 shows the control signal GL, the control signal GH, the magnetizing current I_{T}r and the leakage current I_{Lr} flowing through the series leakage inductance Lr, the current detection signal V_{CS} provided by the current detection resistor RCS, the detection signal V_{S}, the switch voltage V_{DSL} at the node between the upper and lower arm switches SH and SL, the synchronous rectification control signal GSR, the switch voltage V_{DSR} at the node between the synchronous rectification switch SSR and the secondary winding LS, and the discharge current I_{DIS} of the secondary winding LS discharging to charge the output capacitor CO. The switch voltage V_{DSL} is approximately equal to the channel voltage of the lower arm switch SL. The current detection signal V_{CS} is equal to the current I_{CS} flowing through the current detection resistor RCS. When the lower arm switch SL is turned on, the current detection signal V_{CS} can represent the leakage current I_{Lr}. FIG. 2 shows two consecutive switching cycles, each starting with the control signal GL turning on the lower arm switch SL, approximately shortly after the magnetizing current I_{T}r is around OA, and both are switching cycles of the AHB power supply 100 operating in CRM.

As shown in the switching cycle TCYC in FIG. 2, at the beginning, the AHB controller 110 turns on the lower arm switch SL with the control signal GL for a lower arm on-time T_{ON_GL}, and the length of the lower arm on-time T_{ON_GL} can be determined by the compensation signal V_{COMP}. As shown in FIG. 2, at the start of the lower arm on-time T_{ON_GL}, the current detection signal V_{CS} is approximately equal to the initial value V_{CS-INI}; as the lower arm switch SL turns on, the current detection signal V_{CS} gradually increases. When the current detection signal V_{CS} is greater than or equal to the peak value V_{CS-PEAK}, the AHB controller 110 triggers the end of the lower arm on-time T_{ON_GL}, so at the end of the lower arm on-time T_{ON_GL}, the current detection signal V_{CS} is approximately equal to the peak value V_{CS-PEAK}. The compensation signal V_{COMP} determines the peak value V_{CS-PEAK} and also determines the length of the lower arm on-time T_{ON_GL}.

After the lower arm on-time T_{ON_GL} ends, there is a deadtime T_{DLH} during which both the upper and lower arm switches SH and SL are turned off simultaneously.

After the deadtime T_{DLH}, the control signal GH turns on the upper arm switch SH for an upper arm on-time T_{ON_GH}. During the upper arm on-time T_{ON_GH}, the current detection signal V_{CS} is 0V because the leakage current I_{Lr} does not flow through the current detection resistor RCS. The upper arm on-time T_{ON_GH} can be automatically adjusted based the current detection signal V_{CS} or the detection signal V_{S} within the previous lower arm on-time T_{ON_GL}, at least achieving zero voltage switching (ZVS) for the lower arm switch SL in the next switching cycle, and having the ability to adjust the length of the switching cycle TCYC. In FIG. 2, in each switching cycle, the initial value V_{CS-INI} drops to a preset negative value, so it can be inferred that the lower arm switch SL achieved ZVS during this conduction.

After the upper arm on-time T_{ON_GH}, there is a deadtime T_{DHL} during which both the upper and lower arm switches SH and SL are turned off simultaneously. In one embodiment, the deadtime T_{DHL} can be automatically adjusted by the AHB controller 110 based on whether the lower arm switch SL achieves ZVS; when the deadtime T_{DHL} ends, the next switching cycle begins, as shown in FIG. 2.

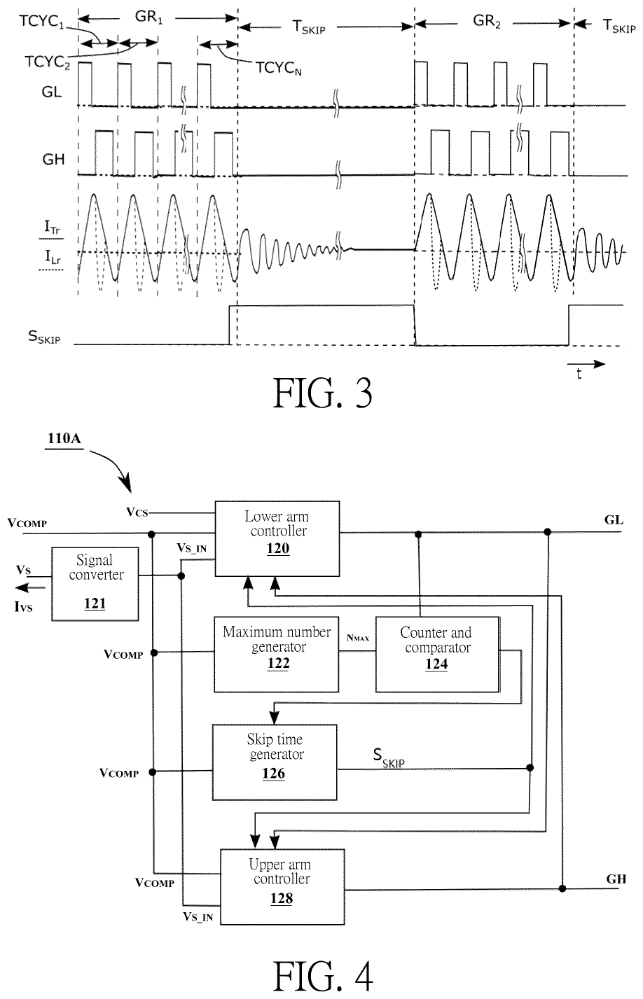

FIG. 3 shows some signal waveforms of the AHB power supply 100 operating in a mixed operation mode according to the present invention. The AHB controller 110 can provide a mixed operation mode. As shown in FIG. 3, in the mixed operation mode, the AHB controller 110 generates switching operation periods GR₁ and GR₂. Each of the switching operation periods GR₁ and GR₂ includes at least one switching cycle, during which the lower arm switch SL and the upper arm switch SH are each turned on only once. As illustrated in FIG. 3, the switching operation period GR₁ includes N switching cycles TCYC₁ to TCYC_{N}. As shown in FIG. 3, the AHB controller 110 internally provides a skip signal S_{SKIP}, where a change in the skip signal S_{SKIP} (e.g., a rising edge) can be used to end the previous switching operation period GR₁ and start the skip time T_{SKIP}; another change in the skip signal S_{SKIP} (e.g., a falling edge) can be used to end the skip time T_{SKIP} and start the next switching operation period GR₂. From the end of the switching operation period GR₁, the AHB controller 110 keeps both the upper arm switch SH and the lower arm switch SL off during the skip time T_{SKIP} until the switching operation period GR₂ begins. In FIG. 3, during each switching cycle, the AHB controller 110 generally automatically adjusts the upper arm on-time T_{ON_GH} and the deadtime T_{DHL} after the upper arm switch SH is turned off, striving to achieve zero voltage switching (ZVS) for the lower arm switch SL in the next switching cycle. In other words, in each switching cycle in FIG. 3, except for the first switching cycle in the switching operation periods GR₁ and GR₂, the AHB power supply 100 operates approximately in CRM, as described previously in FIG. 2.

It should be noted that during the switching operation period, the AHB controller 110 controls the switching of the upper arm switch SH and the lower arm switch SL, so that the resonant circuit RES draws energy from the input voltage V_{IN}, the transformer Tr charges the output capacitor CO, and outputs the output voltage V_{O} across the output voltage line VOUT and the output ground line GNDO to supply power to the load 16. During the skip period, the AHB controller 110 keeps both the upper arm switch SH and the lower arm switch SL off to temporarily suspend the transmission of energy to the output voltage line VOUT. When the load 16 draws less energy, causing the output voltage V_{O} to be too high, the length of the skip period can be adjusted to bring the output voltage V_{O} back to the preset range.

FIG. 4 illustrates the AHB controller 110A. The AHB controller 110A shown in FIG. 4 can serve as the AHB controller 110 in FIG. 1.

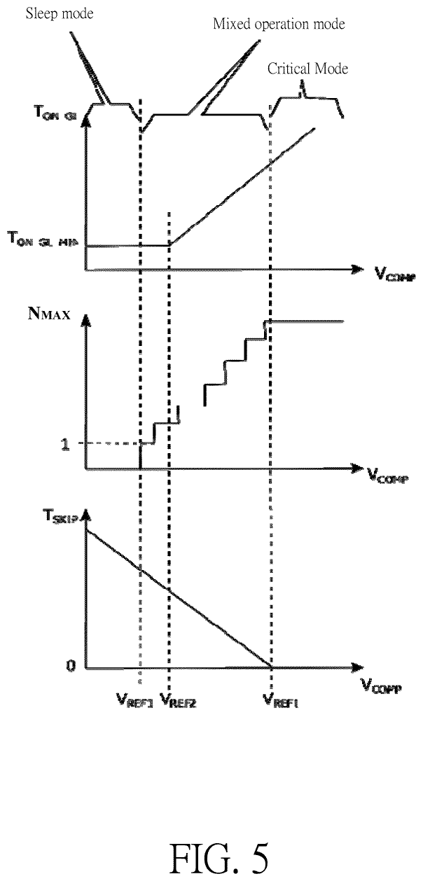

The AHB controller 110A includes a signal converter 121, a lower arm controller 120 (also known as the charging switch controller), a maximum number generator 122, a counter and comparator 124, a skip time generator 126, and an upper arm controller 128 (also known as the resonant switch controller). FIG. 5 shows the relationships between the lower arm on-time T_{ON_GL} and the compensation signal V_{COMP}, the maximum number N_{MAX} and the compensation signal V_{COMP}, and the skip time T_{SKIP} and the compensation signal V_{COMP}, which can be used in the AHB controller 110A.

FIG. 4 and FIG. 5 can be referenced from the teachings of the China Patent Application No. 202310233809.8 (filed on Mar. 13, 2023) and the China Patent Application No. 2023110961429.6 (filed on Aug. 2, 2023) by the same applicant. The entire contents of both patent applications are incorporated herein by reference and will not be repeated.

Please refer to FIG. 3, FIG. 4, and FIG. 5. In the mixed operation mode shown in FIG. 3, FIG. 4, and FIG. 5, the AHB power supply 100 alternates between the switching operation period and the skip period. Although this may increase energy conversion efficiency, it may also imply concerns about poor transient response. For example, if at some point during the switching operation period GR₁ in FIG. 3, the load 16 in FIG. 1 suddenly decreases or disappears, the AHB power supply 100 can only continue to supply energy to the output voltage V_{O} for a maximum number N_{MAX} of consecutive switching cycles, which may lead to the risk of the output voltage V_{O} being too high. Similarly, if the load 16 in FIG. 1 suddenly increases before the skip time T_{SKIP} in FIG. 3 ends, the AHB power supply 100 can only wait for the skip time T_{SKIP} to end before starting to supply energy to the output voltage V_{O}, which may lead to the risk of the output voltage V_{O} being too low. In simple terms, the mixed operation mode in FIG. 3, FIG. 4, and FIG. 5 may result in excessive output ripple of the output voltage V_{O} of the AHB power supply 100.

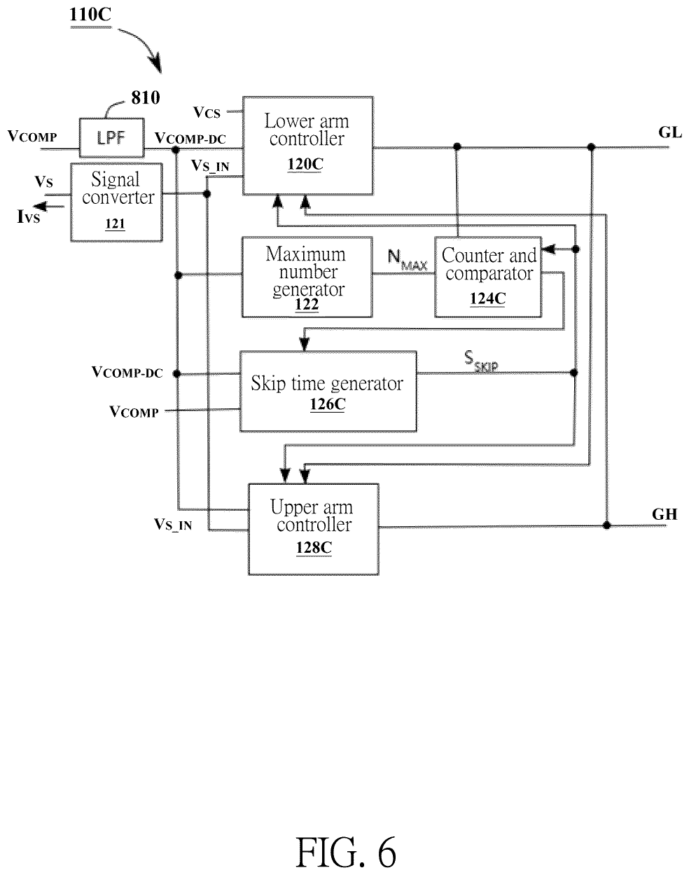

FIG. 6 illustrates the AHB controller 110C, which, in one embodiment, is used to replace the AHB controller 110 in FIG. 1. The AHB controller 110C includes a signal generator 810, a lower arm controller 120C, a maximum number generator 122, a counter and comparator 124C, an skip period generator 126C, and an upper arm controller 128C. It can implement a mixed operation mode and prevent the issue of excessive output ripple. The parts of FIG. 6 that are the same as or similar to those in FIG. 4 can be understood through the teachings previously described for FIG. 4 and will not be repeated here.

In FIG. 6, the signal generator 810 provides a stable compensation signal V_{COMP-DC} based on the compensation signal V_{COMP}. As previously described, the compensation signal V_{COMP} is controlled by the output voltage V_{O}. The stable compensation signal V_{COMP-DC} is also a type of compensation signal that follows the compensation signal V_{COMP} but changes more slowly than the compensation signal V_{COMP}. In one embodiment, the signal generator 810 is a low-pass filter (LPF) that low-pass filters the compensation signal V_{COMP} to generate the stable compensation signal V_{COMP-DC}. In one embodiment, this low-pass filter is composed of resistors and capacitors, and in another embodiment, it is composed of a switching-capacitor circuit. In another embodiment, the signal generator 810 is a sample-and-hold apparatus that periodically samples the compensation signal V_{COMP} to generate the stable compensation signal V_{COMP-DC}. For example, the signal generator 810 samples the compensation signal V_{COMP} approximately once every four switching cycles to serve as the stable compensation signal V_{COMP-DC}.

The AHB controller 110C can provide a mixed operation mode. By comparing the compensation signal V_{COMP} with the stable compensation signal V_{COMP-DC}, the AHB controller 110C can prematurely end a switching operation period and immediately start the skip period T_{SKIP}. By comparing the compensation signal V_{COMP} with the stable compensation signal V_{COMP-DC}, the AHB controller 110C can also prematurely end the skip period T_{SKIP} and immediately start a switching operation period.

Here, the stable compensation signal V_{COMP-DC} is the low-frequency component of the compensation signal V_{COMP}, i.e., the difference between the compensation signal V_{COMP} and the stable compensation signal V_{COMP-DC} is the high-frequency component of the compensation signal V_{COMP}. This high-frequency component can reflect the transient changes in the output voltage V_{O} (i.e., the transient ripple amplitude). By comparing the compensation signal V_{COMP} with the stable compensation signal V_{COMP-DC} to determine the ending and starting of the switching operation period and the skip period, it is possible to effectively reduce the output voltage ripple caused by load changes, making the changes in the output voltage V_{O} smoother when the load suddenly changes, thereby reducing the harm to the load.

Unlike FIG. 4, in FIG. 6, the lower arm controller 120C, the maximum number generator 122, the skip time generator 126C, and the upper arm controller 128C all use the stable compensation signal V_{COMP-DC} as input. The lower arm controller 120C determines the signal peak value V_{CS-PEAK} based on the stable compensation signal V_{COMP-DC} to control the lower arm on-time T_{ON_GL}. The maximum number generator 122 generates the maximum number N_{MAX} based on the stable compensation signal V_{COMP-DC}.

In some embodiments, in the mixed operation mode, the stable compensation signal V_{COMP-DC} and the maximum number N_{MAX} are positively correlated. For example, the larger the stable compensation signal V_{COMP-DC}, the larger the maximum number N_{MAX} generated by the maximum number generator 122.

The counter and comparator 124C count the number of switching cycles N during a switching operation period, and when the number of switching cycles N equals the maximum number N_{MAX}, the skip time generator 126C starts the skip period T_{SKIP}. The counter and comparator 124C reset the number N to 0 each time the skip period T_{SKIP} begins.

The skip time generator 126C determines the maximum skip period T_{SKIP-MAX} based on the stable compensation signal V_{COMP-DC}.

In some embodiments, in the mixed operation mode, the stable compensation signal V_{COMP-DC} and the maximum skip period T_{SKIP-MAX} are inversely correlated. For example, the larger the stable compensation signal V_{COMP-DC}, the smaller the maximum skip period T_{SKIP-MAX} generated by the skip time generator 126C.

The skip time generator 126C uses the skip signal S_{SKIP} to roughly control whether it is currently an skip period or a switching operation period. As previously illustrated in FIG. 3, when the skip signal S_{SKIP} is “1,” it roughly indicates that it is about to be or currently is the skip period T_{SKIP}; when the skip signal S_{SKIP} is “0,” it roughly indicates that it is currently a switching operation period.

When the compensation signal V_{COMP} is lower than the stable compensation signal V_{COMP-DC} and the absolute value of the difference between the compensation signal V_{COMP} and the stable compensation signal V_{COMP-DC} is less than a predetermined value (also known as a preset value) dV1, the skip time generator 126C will end the current switching operation period and start the skip period T_{SKIP} when the number of switching cycles N equals the maximum number N_{MAX}.

Conversely, when the skip time generator 126C finds that the compensation signal V_{COMP} is lower than the stable compensation signal V_{COMP-DC} and the absolute value of the difference between the compensation signal V_{COMP} and the stable compensation signal V_{COMP-DC} is equal to or exceeds a predetermined value dV1, the skip time generator 126C will immediately end the current switching operation period and start an skip period T_{SKIP} after the current switching cycle ends, even if the number of switching cycles N within the current switching operation period is less than the maximum number N_{MAX}. In other words, the number N within a switching operation period can be any integer less than or equal to the maximum number N_{MAX}. If the compensation signal V_{COMP} is too much lower than the stable compensation signal V_{COMP-DC} (exceeding the predetermined value dV1), it indicates that the output voltage V_{O} may be too high. Interrupting the current switching operation period at this time can prevent the output voltage V_{O} from being excessively increased, thereby reducing output ripple.

When the compensation signal V_{COMP} is higher than the stable compensation signal V_{COMP-DC} and the absolute value of the difference between the compensation signal V_{COMP} and the stable compensation signal V_{COMP-DC} is less than a predetermined value dV2, the skip time generator 126C provides the maximum skip period T_{SKIP-MAX} internally based on the stable compensation signal V_{COMP-DC}. When the skip period T_{SKIP} lasts until it equals the maximum skip period T_{SKIP-MAX}, the skip time generator 126C will end the current skip period T_{SKIP} and start a switching operation period.

Conversely, when the skip time generator 126C finds that the compensation signal V_{COMP} is higher than the stable compensation signal V_{COMP-DC} and the absolute value of the difference between the compensation signal V_{COMP} and the stable compensation signal V_{COMP-DC} is equal to or exceeds the predetermined value dV2, the skip time generator 126C will immediately end the current skip period T_{SKIP} and start a switching operation period, even if the current skip period T_{SKIP} has not yet reached the maximum skip period T_{SKIP-MAX}. In other words, the skip period T_{SKIP} can be any duration less than or equal to the maximum skip period T_{SKIP-MAX}. If the compensation signal V_{COMP} is too much higher than the stable compensation signal V_{COMP-DC} (exceeding the predetermined value dV2), it indicates that the output voltage V_{O} may be too low. Ending the skip period T_{SKIP} and starting to supply power to the output voltage V_{O} at this time can prevent the output voltage V_{O} from being too low, thereby reducing output ripple. The predetermined values dV1 and dV2 can be the same or different.

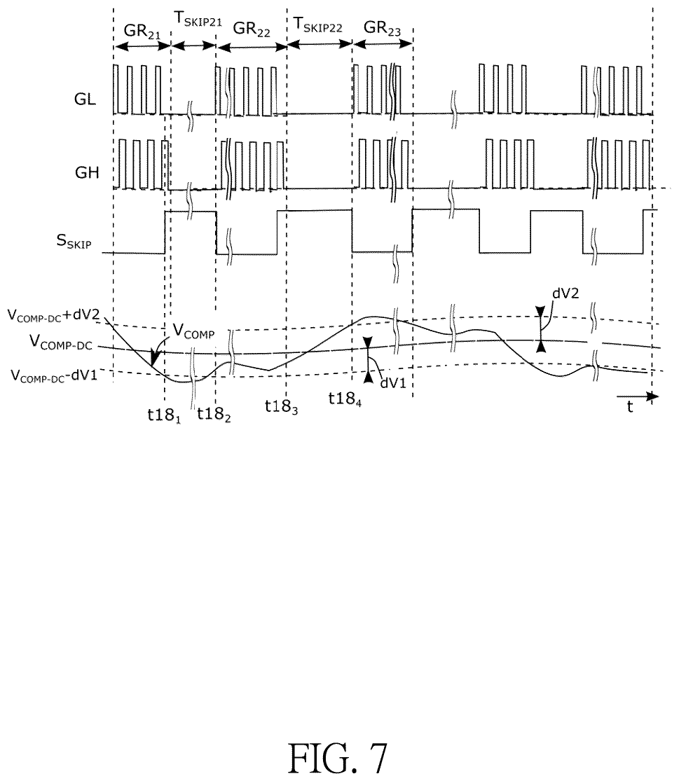

FIG. 7 shows some signal waveforms that may be generated in the mixed operation mode when the AHB power supply 100 in FIG. 1 uses the AHB controller 110C. From top to bottom, FIG. 7 shows, in one embodiment, the control signal GL, the control signal GH, the skip signal S_{SKIP}, the compensation signal V_{COMP}, and the stable compensation signal V_{COMP-DC}.

As can be seen from FIG. 7, the stable compensation signal V_{COMP-DC} roughly follows the compensation signal V_{COMP} and changes more slowly than the compensation signal V_{COMP}.

At time point t18₁, the compensation signal V_{COMP} is lower than the stable compensation signal V_{COMP-DC}, and the difference between the two reaches the first predetermined value dV1. Therefore, the skip time generator 126C ends the switching operation period GR₂₁ and starts the skip period T_{SKIP21}. The number of switching cycles N in the switching operation period GR₂₁ will not exceed the maximum number N_{MAX} corresponding to the stable compensation signal V_{COMP-DC} at that time.

During the skip period T_{SKIP21}, the compensation signal V_{COMP} remains lower than the sum of the stable compensation signal V_{COMP-DC} and the second predetermined value dV2. Therefore, the skip period T_{SKIP21} continues for the maximum skip period T_{SKIP-MAX} corresponding to the stable compensation signal V_{COMP-DC} at that time and ends at time point t182. The length of the skip period T_{SKIP21} will be approximately equal to the maximum skip period T_{SKIP-MAX}.

During the switching operation period GR₂₂, the compensation signal V_{COMP} remains higher than the stable compensation signal V_{COMP-DC} minus the first predetermined value dV1 (i.e., the difference between the two does not reach the first predetermined value dV1). Therefore, the number of switching cycles N in the switching operation period GR₂₂ will equal the maximum number N_{MAX} corresponding to the stable compensation signal V_{COMP-DC} at that time, and the switching operation period GR₂₂ ends at time point t183. The number of switching cycles N in the switching operation period GR₂₂ will eventually equal the maximum number N_{MAX}.

At time point t184, the compensation signal V_{COMP} is higher than the stable compensation signal V_{COMP-DC}, and the difference between the two reaches the second predetermined value dV2. Therefore, the skip time generator 126C ends the skip period T_{SKIP22} and starts the switching operation period GR₂₃. The length of the skip period T_{SKIP22} will not exceed the maximum skip period T_{SKIP-MAX} corresponding to the stable compensation signal V_{COMP-DC} at that time.

FIG. 6 provides a control method that switches between the switching operation period and the skip period in the mixed operation mode by comparing the compensation signal V_{COMP} with the stable compensation signal V_{COMP-DC}. This control method is not limited to use only in AHB power supplies but can also be applied to other switch-mode power supplies. For example, a flyback power supply implemented according to the present invention can also have the compensation signal V_{COMP} and the stable compensation signal V_{COMP-DC}, and can operate in a mixed operation mode with alternating switching operation periods and skip periods. The switching between the switching operation period and the skip period is achieved by comparing the compensation signal V_{COMP} with the stable compensation signal V_{COMP-DC}.

In the above embodiments, a mixed operation mode suitable for a medium load condition is provided. In the mixed operation mode, the switch-mode power supply alternates between a switching operation period and an skip period. The switching operation period includes at least one switching cycle, during which the power switch is turned on once in each switching cycle, while the power switch remains off during the skip period. Based on the stable compensation signal, the maximum number of switching cycles in the switching operation period and the maximum skip period can be determined. By comparing (1) the compensation signal controlled by the output voltage and (2) the stable compensation signal, which is the low-frequency component of the compensation signal, the switching operation period can be selectively ended before reaching the maximum number of switching cycles, or the skip period can be selectively ended before reaching the maximum skip period. Since the difference between the compensation signal and the stable compensation signal can more accurately reflect the transient changes in the output voltage, the switching operation period and the skip period can be timely adjusted based on the difference between the compensation signal and the stable compensation signal when the output voltage changes due to sudden load changes. This makes the changes in the output voltage smoother (i.e., reduces the output voltage ripple), effectively reducing the potential sudden changes in the output voltage during the process of the load changing from medium to heavy or from medium to light, thereby reducing the harm to the load.

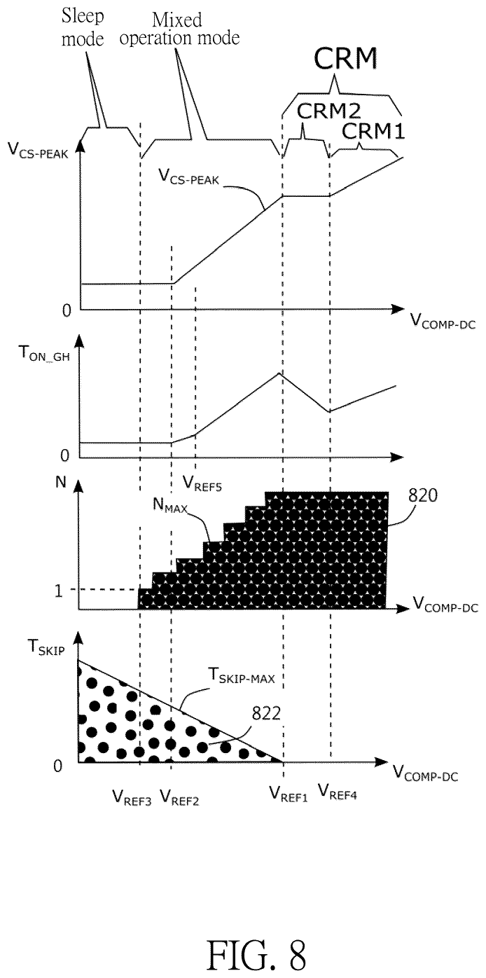

FIG. 8 shows some signal waveforms generated when the AHB power supply 100 in FIG. 1 operates in different modes with the AHB controller 110C, depending on the stable compensation signal V_{COMP-DC}. FIG. 8 is similar to FIG. 5, and the same or similar parts can be understood from the previous teachings and will not be repeated here.

FIG. 8 shows the relationships between the signal peak value V_{CS-PEAK} and the stable compensation signal V_{COMP-DC}, the upper arm on-time T_{ON_GH} and the stable compensation signal V_{COMP-DC}, the number N and the stable compensation signal V_{COMP-DC}, and the skip time T_{SKIP} and the stable compensation signal V_{COMP-DC}, which can be used in the AHB controller 110C in FIG. 6. As shown in FIG. 8, the stable compensation signal V_{COMP-DC} controls the signal peak value V_{CS-PEAK} and the upper arm on-time T_{ON_GH} in each switching cycle. As previously mentioned, the stable compensation signal V_{COMP-DC} or the compensation signal V_{COMP} can correspond to the load 16. When the output voltage V_{O} is regulated to a stable voltage, the heavier the load 16, the higher the stable compensation signal V_{COMP-DC} or the compensation signal V_{COMP}. Therefore, FIG. 8 essentially shows the relationships between the signal peak value V_{CS-PEAK}, the upper arm on-time T_{ON_GH}, the number N, and the skip time T_{SKIP} with respect to the load 16.

The number N counted by the counter and comparator 124C will not exceed the maximum number N_{MAX}. In FIG. 8, the number N can be any integer within the shaded area 820 under the maximum number N_{MAX} curve. Similarly, the actual skip period T_{SKIP} will not exceed the maximum skip period T_{SKIP-MAX}. In FIG. 8, the skip period T_{SKIP} can fall within the shaded area 822 under the maximum skip period T_{SKIP-MAX}.

In FIG. 8, when the stable compensation signal V_{COMP-DC} exceeds the reference voltage V_{REF1}, the load 16 is considered to be heavy, and the AHB power supply 100 operates approximately in CRM. When the stable compensation signal V_{COMP-DC} is between the reference voltage V_{REF1} and the reference voltage V_{REF3}, the load 16 is considered to be medium, and the AHB power supply 100 operates approximately in the mixed operation mode. When the stable compensation signal V_{COMP-DC} is below the reference voltage V_{REF3}, the load 16 is considered to be nonexistent, or in a no-load state, and the AHB power supply 100 operates in sleep mode. In FIG. 8, the reference voltage V_{REF2} is between the reference voltage V_{REF1} and the reference voltage V_{REF3}.

In some embodiments, based on the output voltage of the AHB controller 100, a compensation signal is provided; the charging switch is turned on for a charging switch on-time; the resonant switch is turned on for a resonant switch on-time; and based on the compensation signal, the resonant switch on-time is regulated so that the resonant switch on-time increases as the load decreases.

Here, “regulating the resonant switch on-time based on the compensation signal so that the resonant switch on-time increases as the load decreases” implies that there is a phase where the resonant switch on-time decreases as the load decreases. During the process of load reduction, the phase where “the resonant switch on-time decreases as the load decreases” precedes the phase where “the resonant switch on-time increases as the load decreases based on the compensation signal.”

Thus, during the process of the load changing from heavy to medium (i.e., the process of load reduction), the ripple of the output voltage V_{O} is reduced, which helps to minimize damage to the load.

Specifically, as shown in FIG. 8, CRM is further divided into two types: CRM1, where the stable compensation signal V_{COMP-DC} is higher than the reference voltage V_{REF4}, and CRM2, where the stable compensation signal V_{COMP-DC} is between the reference voltage V_{REF4} and V_{REF1}. As shown in FIG. 8, when operating in CRM1 (where the stable compensation signal V_{COMP-DC} is higher than the reference voltage V_{REF4}), the signal peak value VCS-PEAK that controls the turn-off point of the lower arm switch SL decreases as the stable compensation signal V_{COMP-DC} decreases; the upper arm on-time T_{ON_GH} also decreases as the stable compensation signal V_{COMP-DC} decreases. When operating in CRM2 (where the stable compensation signal V_{COMP-DC} is between the reference voltage V_{REF4} and V_{REF1}), the signal peak value V_{CS-PEAK} that controls the turn-off point of the lower arm switch SL remains approximately constant and does not change with the stable compensation signal V_{COMP-DC}; the upper arm on-time TON GH increases as the stable compensation signal V_{COMP-DC} decreases, thereby ensuring an increase in the length of a switching cycle.

In FIG. 8, when operating in the mixed operation mode, the signal peak value V_{CS}-PEAK generally decreases as the stable compensation signal V_{COMP-DC} decreases. When the stable compensation signal V_{COMP-DC} is lower than the reference voltage V_{REF2}, the signal peak value V_{CS-PEAK} remains approximately constant. As shown in FIG. 8, when operating in the mixed operation mode, the upper arm on-time T_{ON_GH} generally shortens as the stable compensation signal V_{COMP-DC} decreases; when the stable compensation signal V_{COMP-DC} is lower than the reference voltage V_{REF2}, the upper arm on-time T_{ON_GH} remains approximately constant.

When operating in CRM2, for the same signal peak value V_{CS-PEAK}, an increase in the upper arm on-time T_{ON_GH} will result in a longer switching cycle and less energy being transferred to the output voltage V_{O} within a switching cycle, both of which will lead to a reduction in average conversion power. Therefore, a longer upper arm on-time T_{ON_GH} is suitable for lower stable compensation signals V_{COMP-DC} or lower compensation signals V_{COMP} that require less conversion power.

The relationship between the stable compensation signal V_{COMP-DC} and the signal peak value V_{CS-PEAK} and the upper arm on-time T_{ON_GH} shown in FIG. 8 is just an example and is not intended to limit the present invention. For example, in other embodiments, when operating in CRM1 and CRM2, the upper arm on-time T_{ON_GH} may generally increase as the stable compensation signal V_{COMP-DC} decreases.

The relationship between the stable compensation signal V_{COMP-DC} and the signal peak value V_{CS-PEAK} and the upper arm on-time T_{ON_GH} illustrated in FIG. 8 can also be applied to embodiments without the stable compensation signal V_{COMP-DC}, but using the compensation signal V_{COMP} to generate the signal peak value V_{CS-PEAK} and the upper arm on-time TON GH. For example, in one embodiment, the stable compensation signal V_{COMP-DC} in FIG. 8 can be replaced with the compensation signal V_{COMP} to show the relationship between the compensation signal V_{COMP} and the signal peak value V_{CS-PEAK} and the upper arm on-time T_{ON_GH} in FIG. 4, allowing the AHB controller 110A in FIG. 4 to operate in CRM1 and CRM2.

It should be noted that, compared to the related technology where the resonant switch on-time continuously decreases as the load decreases during the process of the load changing from heavy to medium, in the embodiments of the present invention, CRM is further divided into CRM1 and CRM2 under heavy load conditions. CRM2 can be understood as a transitional mode from CRM1 to the mixed operation mode, where the resonant switch on-time is regulated based on the compensation signal to increase as the load decreases. Thus, by regulating the upper arm on-time T_{ON_GH} to increase as the load decreases, the length of at least one switching cycle is extended during the process of the load changing from heavy to medium, resulting in less energy being transferred to the output voltage V_{O} per unit time. This not only reduces the switching frequency and the associated losses but also allows the power supply to operate in critical mode under medium load conditions without needing to activate the skip time T_{SKIP}, reducing the ripple of the output voltage V_{O} and making the changes in the output voltage smoother when the load suddenly changes, thereby reducing the harm to the load.

In some embodiments, the resonant switch on-time can be regulated based on the stable compensation signal so that the resonant switch on-time increases as the load decreases. For example, the debounce time can be controlled based on the stable compensation signal, and when the resonant switch is turned off, it can be detected whether the charging switch meets the predetermined condition for being capable of performing ZVS to provide a comparison result. The comparison result is checked to see if it maintains a first logic value for a debounce time to control the length of the resonant switch on-time.

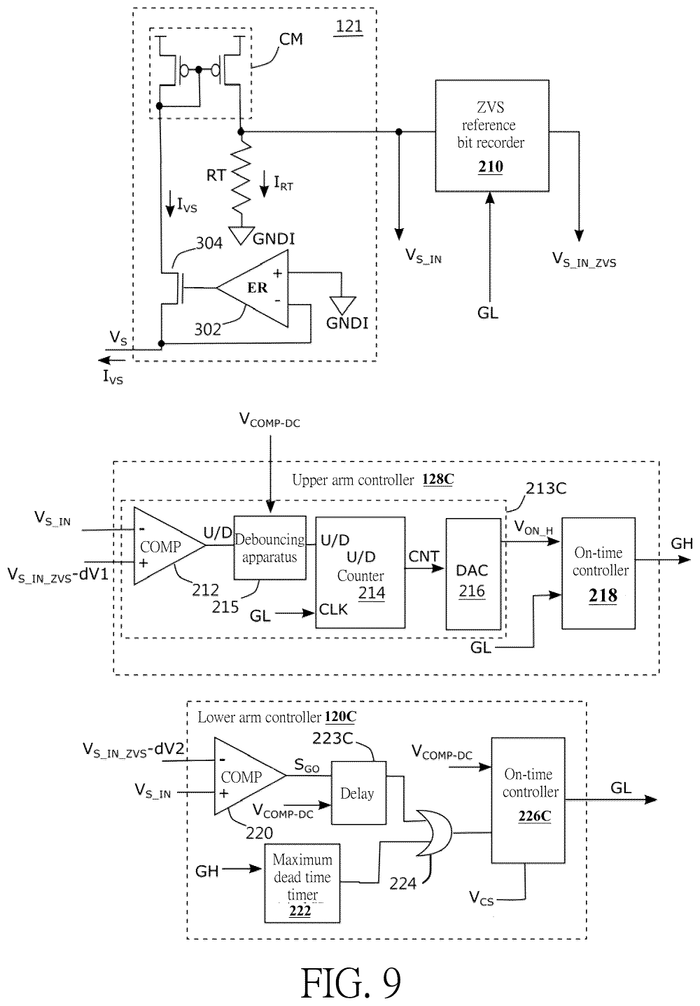

FIG. 9 illustrates a circuit diagram where the signal converter 121, the upper arm controller 128C, and the lower arm controller 120C from FIG. 6 operate together with a ZVS reference bit recorder 210. Some parts of the circuit and related operations can be referenced from the descriptions in the China Patent Application No. 202310961429.6 (filed on Aug. 2, 2023) by the same applicant. However, FIG. 9 at least adds a debouncing apparatus 215 and a delay 223C, along with some circuit parts and related operations.

The signal converter 121 indirectly detects the switch voltage V_{DSL} by detecting the winding voltage V_{AUX} to provide the detection signal V_{S_IN}. As shown in FIG. 9, the signal converter 121 uses an operational amplifier 302 and an NMOS switch 304 to clamp the detection signal V_{S} to no less than 0V. Through the cooperation of the current mirror CM, the operational amplifier 302, and the NMOS switch 304, when the winding voltage V_{AUX} is negative, the detection signal V_{S_IN} is approximately equal to |V_{AUX}|/R1*RT, where RT represents the resistance value of resistor RT.

In FIG. 9, the ZVS reference bit recorder 210 samples the detection signal V_{S_IN} at a preset time point within the lower arm on-time T_{ON_GL} to generate the ZVS reference bit V_{S_IN_ZVS}. For example, at the minimum on-time T_{ON_GL} MIN after the start of the lower arm on-time T_{ON_GL}, the ZVS reference bit recorder 210 samples the detection signal V_{S_IN} as the ZVS reference bit V_{S_IN_ZVS}. The ZVS reference bit recorder 210 records the stable value of the detection signal V_{S_IN} when the lower arm switch SL is stably on and the switch voltage V_{DSL} is 0V. Simply put, the detection signal VS IN approximately corresponds to the real-time changing switch voltage V_{DSL}, while the ZVS reference bit V_{S_IN_ZVS} approximately corresponds to the ground voltage (0V) transmitted by the input ground line GND when the lower arm switch SL is on. Therefore, comparing the detection signal VS IN with the ZVS reference bit V_{S_IN_ZVS} is equivalent to comparing the switch voltage V_{DSL} with 0V.

In FIG. 9, the upper arm controller 128C can automatically adjust the upper arm on-time T_{ON_GH} based on whether the lower arm switch SL can achieve ZVS (i.e., whether the charging switch meets the predetermined condition for being capable of performing ZVS) and whether this state lasts for the debounce time T_{DEB}. The upper arm controller 128C includes a ZVS detection circuit 213C and an on-time controller 218. The ZVS detection circuit 213C includes a comparator 212, a debouncing apparatus 215, a counter 214, and a digital-to-analog converter (DAC) 216.

When the control signal GL switches, the ZVS detection circuit 213C detects whether the lower arm switch SL is in a state that can achieve ZVS (with the switch voltage V_{DSL} approximately equal to 0V) and whether this state lasts for the debounce time T_{DEB}. Based on this, it adjusts the analog reference bit V_{ON_H}, which is a length parameter in analog form that can reflect the upper arm on-time T_{ON_GH} within a switching cycle. The on-time controller 218 starts turning on the upper arm switch SH at an appropriate time after the control signal GL turns off the lower arm switch SL, and the length of the upper arm on-time T_{ON_GH} is determined based on the analog reference bit V_{ON_H}.

The comparator 212 compares the detection signal VS IN with the ZVS reference bit V_{S_IN_ZVS}-dV1 to generate a comparison result U/D.

During the process of the switch voltage V_{DSL} decreasing towards 0V, the detection signal VS IN gradually rises from a negative value and approaches the ZVS reference bit V_{S_IN_ZVS}. Therefore, when the detection signal V_{S_IN}>(V_{S_IN_ZVS}-dV1), it is determined that the lower arm switch SL can achieve zero voltage switching (ZVS). From another perspective, the comparator 212 detects whether the switch voltage V_{DSL} is approximately equal to 0V. Before the lower arm switch SL is about to turn on, if the switch voltage V_{DSL} is too high and far from 0V, V_{S_IN}<(V_{S_IN_ZVS}-dV1), the comparison result U/D is logically “1,” meaning that the lower arm switch SL will not achieve ZVS. Conversely, if the switch voltage V_{DSL} is close enough to 0V, V_{S_IN}>(V_{S_IN_ZVS}-dV1), the comparison result U/D is logically “0,” meaning that the lower arm switch SL is in a state that can achieve ZVS.

The debouncing apparatus 215 only transmits a logical “0” to the counter 214 if the comparison result U/D remains “0” for the debounce time T_{DEB}; otherwise, it continuously provides a logical “1” to the counter 214. From another perspective, a comparison result U/D that is logically “1” is directly transmitted to the counter 214 by the debouncing apparatus 215. The debounce time T_{DEB} is determined based on the stable compensation signal V_{COMP-DC}, which will be explained later.

The counter 214 uses the edge of the control signal GL that turns on the lower arm switch SL as the clock signal. Based on the output of the debouncing apparatus 215, it counts up or down and outputs a count CNT. The digital-to-analog converter 216 converts the digital count CNT to output the analog reference bit V_{ON_H}. The on-time controller 218 determines the length of the upper arm on-time T_{ON_GH} based on the analog reference bit V_{ON_H}.

The edge of the control signal GL that turns on the lower arm switch SL will turn on the lower arm switch SL, causing the main winding LP to start charging and magnetizing with the input voltage VIN. This also causes the auxiliary winding voltage V_{AUX} to be clamped to a significantly negative voltage, making the detection signal V_{S_IN} rise to a peak, approximately equal to the ZVS reference bit V_{S_IN_ZVS}. However, due to signal transmission delay, there is a time difference between the edge of the control signal GL that turns on the lower arm switch SL and the actual clamping of the winding voltage V_{AUX}. Nevertheless, the counter 214 can determine from the output of the debouncing apparatus 215 and the control signal GL whether the switch voltage V_{DSL} is approximately 0 (i.e., the difference between the detection signal V_{S_IN} and the ZVS reference bit V_{S_IN_ZVS} is not greater than the predetermined value dV1) before the lower arm switch SL is turned on, which is equivalent to determining whether the lower arm switch SL can achieve ZVS.

Before the lower arm switch SL is turned on, the state that “the lower arm switch SL can achieve ZVS” (i.e., the charging switch meets the predetermined condition for being capable of performing ZVS) must also be maintained for the debounce time T_{DEB} before the counter 214 counts down to reduce the length of the upper arm on-time T_{ON_GH}. Conversely, if this state does not occur or is not maintained for the debounce time T_{DEB}, the counter 214 counts up, increasing the length of the upper arm on-time T_{ON_GH}. Therefore, the length of the upper arm on-time T_{ON_GH} will approximately be maintained at a level that allows the lower arm switch SL to achieve ZVS for the debounce time T_{DEB}.

In FIG. 9, the lower arm controller 120C can automatically determine the length of the dead time T_{DHL} and provide the control signal GL at the appropriate time to start turning on the lower arm switch SL. The lower arm controller 120C includes a comparator 220, a delay 223C, a maximum dead time timer 222, an OR gate 224, and an on-time controller 226C.

Similar to comparator 212, comparator 220 also compares the detection signal V_{S_IN} with the ZVS reference bit V_{S_IN_ZVS} to generate the trigger signal S_{GO}. If the lower arm switch SL achieves ZVS at the moment it is turned on, the comparison result U/D output by comparator 212 will change from a logical “1” to “0” approximately before the lower arm switch SL is actually turned on. Comparator 220 should be designed to make the logical change of the trigger signal S_{GO} occur earlier than the logical change of the comparison result U/D. For example, in FIG. 6, the predetermined value dV1 is 0.1V, and the predetermined value dV2 is 0.2V. Thus, during the dead time T_{DHL}, as the winding voltage V_{AUX} gradually decreases and the detection signal V_{S_IN} N gradually increases, when the detection signal V_{S_IN} gradually increases and exceeds the ZVS reference bit V_{S_IN_ZVS}-dV2 (e.g., V_{S_IN_ZVS}-0.2V), the trigger signal S_{GO} is output, triggering the subsequent provision of the control signal GL. When the CLK input of the counter 214 receives the control signal GL, it checks whether the comparison result U/D of the detection signal V_{S_IN} and the ZVS reference bit V_{S_IN_ZVS}-dV1 (e.g., V_{S_IN_ZVS}-0.1V) has remained at 0 for the debounce time T_{DEB}. If the comparison result U/D remains at 0 for the debounce time T_{DEB}, the count CNT output by the counter 214 decreases; if the comparison result U/D remains at 0 for less than the debounce time T_{DEB}, the count CNT output by the counter 214 increases.

Thus, adjusting the upper arm switch GH's on-time only after the comparison result U/D has remained at 0 for the debounce time T_{DEB} (i.e., only after the counter 214 changes its count) can further extend the length of the switching cycle in CRM2, resulting in less energy being transferred to the output voltage V_{O} per unit time. This not only reduces the switching frequency and the associated losses but also allows the power supply to operate in critical mode under medium load conditions without needing to activate the skip time T_{SKIP}, further reducing the ripple of the output voltage V_{O} and making the changes in the output voltage smoother when the load suddenly changes, thereby further reducing the harm to the load.

The on-time controller 226C triggers the lower arm switch SL to turn on after a predetermined delay time following the logical change of the trigger signal S_{GO}, starting the lower arm on-time T_{ON_GL}. The signal peak value V_{CS-PEAK} and the length of the lower arm on-time T_{ON_GL} are determined based on the stable compensation signal V_{COMP-DC}.

The maximum dead time timer 222 starts timing after the upper arm on-time T_{ON_GH} ends, providing the maximum dead time T_{DEAD_MAX}. If the trigger signal S_{GO} does not trigger the on-time controller 226C, the maximum dead time timer 222 can trigger the on-time controller 226C to start the lower arm on-time T_{ON_GL} after the maximum dead time T_{DEAD_MAX} has passed. The maximum dead time timer 222 prevents the situation where the trigger signal S_{GO} from comparator 220 does not produce a logical change, and the switching cycle cannot end when the lower arm switch SL does not achieve ZVS. In other words, the maximum dead time timer 222 ensures that the dead time T_{DHL} does not exceed the maximum dead time T_{DEAD_MAX}.

The delay 223C delays the trigger signal S_{GO} by the delay time T_{DL} before sending it to the OR gate 224, triggering the lower arm switch SL to turn on.

Thus, by delaying the trigger signal S_{GO} by the delay time T_{DL} after its logical change before transmitting it to the on-time controller 226C to turn on the lower arm switch SL, the length of the switching cycle in CRM2 mode can be further extended, resulting in less energy being transferred to the output voltage V_{O} per unit time. This not only reduces the switching frequency and the associated losses but also allows the power supply to operate in critical mode under medium load conditions without needing to activate the skip time T_{SKIP}, further reducing the ripple of the output voltage V_{O} and making the changes in the output voltage smoother when the load suddenly changes, thereby further reducing the harm to the load.

In one embodiment, the length of the delay time T_{DL} is approximately the same as the debounce time T_{DEB}, both being controlled by the stable compensation signal V_{COMP-DC}. In another embodiment, the lengths of the delay time T_{DL} and the debounce time T_{DEB} can be different.

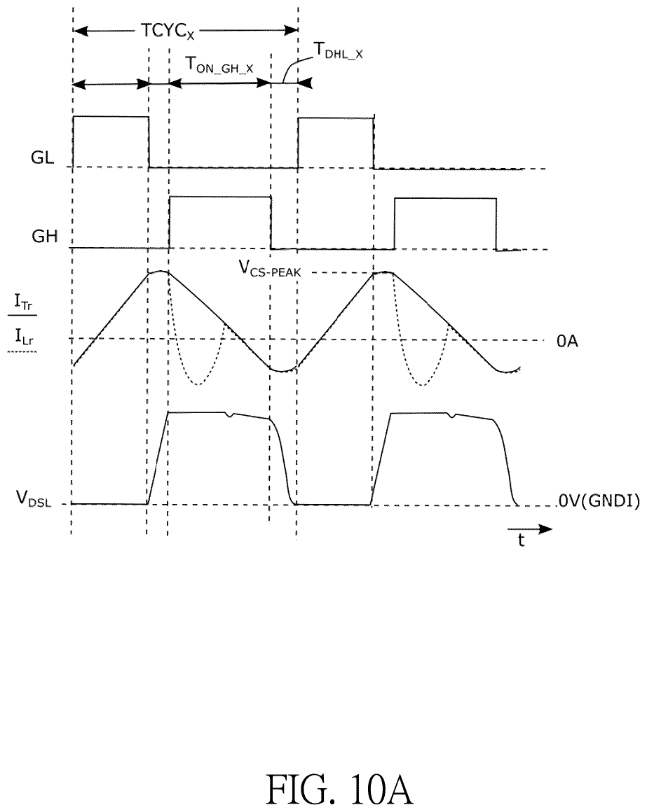

FIG. 10A and FIG. 10B respectively show the signal waveforms that may be generated by the AHB power supply 100 under the control of the AHB controller 110C, with and without the debounce time T_{DEB} (equal to 0 seconds and greater than 0 seconds, respectively). FIG. 10A shows the switching cycle TCYC_{X}, while FIG. 10B shows four consecutive switching cycles, with the first two labeled as switching cycle TCYC_{Y1} and switching cycle TCYC_{Y2}. In FIG. 10A and FIG. 10B, the debounce time T_{DEB} and the delay time T_{DL} are assumed to be equal.

As shown in FIG. 10A, because the debounce time T_{DEB} is C seconds, the upper arm controller 128C makes the upper arm on-time T_{ON_GH_X} just long enough to ensure that the switch voltage V_{DSL} is exactly 0V before the lower arm switch SL is turned on, achieving ZVS. The length of the dead time T_{DHL_X} also ends approximately when the switch voltage V_{DSL} is about 0V.

In FIG. 10B, the debounce time T_{DEB} and the delay time T_{DL} are greater than 0. Compared to FIG. 10A, the end of the dead times T_{DHL_Y1} and T_{DHL_Y2} in FIG. 10B are delayed by the delay time T_{DL} (equal to the debounce time T_{DEB}). In FIG. 10B, the delay time T_{DL} starts approximately when the switch voltage V_{DSL} drops to CV (when the detection signal V_{S_IN} gradually increases from less than or equal to V_{S_IN_ZVS}-dV2 to greater than V_{S_IN_ZVS}-dV2) and ends when the lower arm switch SL starts to turn on. Compared to FIG. 10A, the upper arm controller 128C makes both the upper arm on-time T_{ON_GH_Y1} and T_{ON_GH_Y2} longer, causing the leakage inductance current I_{Lr} and the magnetizing current IT, to be more negative. This results in the switch voltage V_{DSL} being clamped to a small negative voltage by the body diode of the lower arm switch SL for approximately the debounce time T_{DEB} during the dead times T_{DHL_Y1} or T_{DHL_Y2}. The upper arm controller 128C automatically adjusts the upper arm on-time T_{ON_GH} so that the lower arm switch SL can achieve ZVS (e.g., detection signal V_{S_IN} greater than V_{S_IN_ZVS}-dV1) for the debounce time T_{DEB}.

FIG. 10B also shows the comparison result U/D and the count CNT changing over time. At the beginning of the switching cycle TCYC_{Y1}, assuming the count CNT is the integer N_{GH}, the corresponding upper arm on-time T_{ON_GH_Y1} is generated. At the end of the upper arm on-time T_{ON_GH_Y1}, the leakage inductance current I_{Lr} is approximately the value I_{Lr_Y1}, causing the switch voltage V_{DSL} to quickly drop at the beginning of the dead time T_{DHL_Y1}. When the switch voltage V_{DSL} is approximately 0V, the debounce time T_{DEB} (or delay time T_{DL}) starts, as shown in FIG. 10B. During the debounce time T_{DEB} in the switching cycle TCYC_{Y1}, because the detection signal V_{S_IN} remains greater than V_{S_IN_ZVS}-dV1, indicating that the switch voltage V_{DSL} is approximately less than or equal to 0V, the comparison result U/D remains logically “0,” indicating that the lower arm switch SL is in a state that can achieve ZVS. This means that the upper arm on-time T_{ON_GH_Y1} is sufficiently long, so the count CNT decreases by one at time t_{Y2}, becoming the integer N_{GH} minus 1.

In the switching cycle TCYC_{Y2}, the upper arm on-time T_{ON_GH_Y2} corresponds to the integer N_{GH} minus 1, which is shorter than the upper arm on-time T_{ON_GH_Y1}. At the end of the shorter upper arm on-time T_{ON_GH_Y2}, the leakage inductance current I_{Lr} is approximately the value I_{Lr_Y2}, whose absolute value is less than the absolute value of I_{Lr_Y1}, as shown in FIG. 10B. The leakage inductance current I_{Lr} of value I_{Lr_Y2} causes the detection signal V_{S_IN} to be lower than V_{S_IN_ZVS}-dV1 before the debounce time T_{DEB} ends during the dead time T_{DHL_Y2}, indicating that the switch voltage V_{DSL} has turned from negative to positive.

Therefore, before the end of the dead time T_{DHL_Y2}, the comparison result U/D becomes logically “1,” indicating that the lower arm switch SL is no longer in a state that can achieve ZVS. This means that the upper arm on-time T_{ON_GH_Y1} is insufficient, so the count CNT increases by one at time t_{Y3}, becoming the integer N_{GH}.

If the load requiring power in FIG. 10B remains unchanged, it can be expected that the switching cycles TCYC_{Y1} and TCYC_{Y2} will alternate, causing the count CNT to be either the integer N_{GH} or the integer N_{GH} minus one. Thus, the upper arm controller 128C automatically adjusts the upper arm on-time T_{ON_GH} so that the lower arm switch SL can achieve ZVS for approximately the debounce time T_{DEB}.

From FIG. 10B and FIG. 10A, it can be seen that for the same signal peak value V_{CS-PEAK}, a longer debounce time T_{DEB} will result in a longer upper arm on-time T_{ON_GH}, a longer dead time T_{DHL}, and a slower switching cycle.

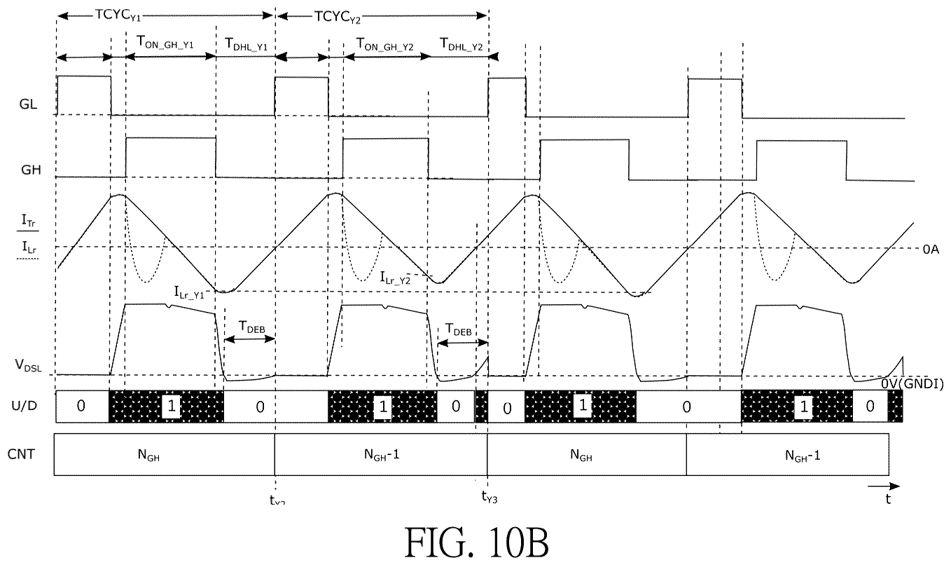

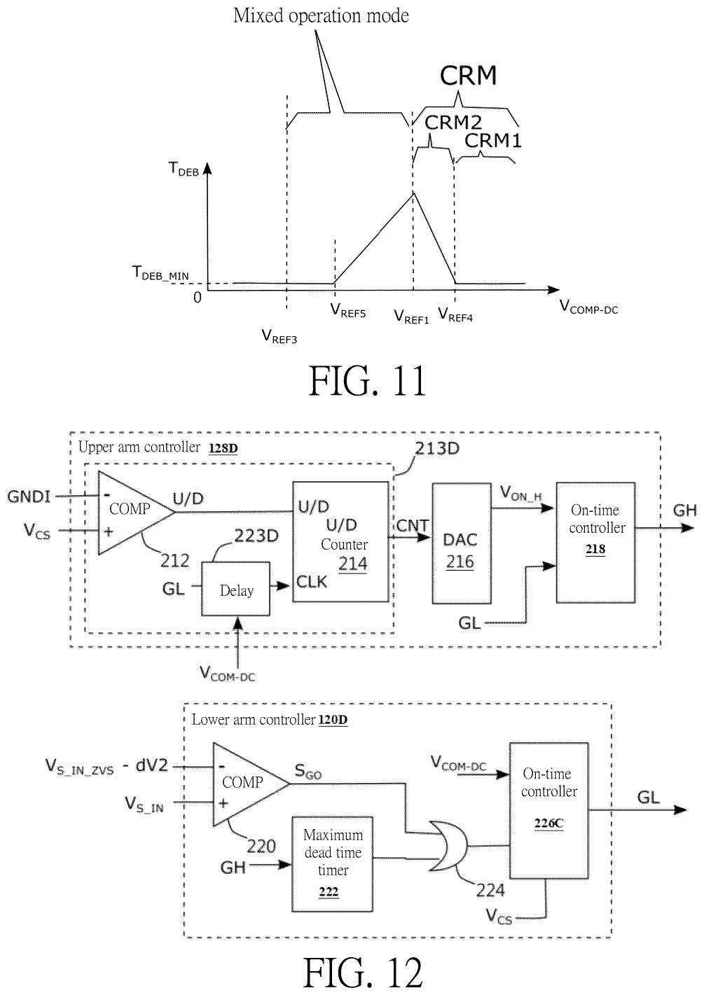

FIG. 11 shows the relationship between the debounce time T_{DEB} and the stable compensation signal V_{COMP-DC}. As shown in FIG. 11, when the stable compensation signal V_{COMP-DC} is between the reference voltages V_{REF4} and V_{REF1}, the debounce time T_{DEB} increases as the stable compensation signal V_{COMP-DC} decreases. When the stable compensation signal V_{COMP-DC} is between the reference voltages V_{REF1} and V_{REF5}, the debounce time T_{DEB} decreases as the stable compensation signal V_{COMP-DC} decreases. When the stable compensation signal V_{COMP-DC} is not between the reference voltages V_{REF4} and V_{REF5}, the debounce time T_{DEB} is fixed at the minimum debounce time T_{DEB_MIN}, which can be 0 seconds in some embodiments.

Refer to FIG. 11 and FIG. 8. When operating in CRM1, since the debounce time T_{DEB} remains unchanged, the upper arm on-time T_{ON_GH} is roughly proportional to the signal peak value V_{CS-PEAK} or decreases as the signal peak value V_{CS-PEAK} decreases. When operating in CRM2, although the signal peak value V_{CS-PEAK} remains unchanged, the upper arm on-time T_{ON_GH} increases to accommodate the longer debounce time T_{DEB}. When the stable compensation signal V_{COMP-DC} is between the reference voltages V_{REF1} and V_{REF5}, since both the signal peak value V_{CS-PEAK} and the debounce time T_{DEB} decrease as the stable compensation signal V_{COMP-DC} decreases, the upper arm on-time T_{ON_GH} will shorten as the stable compensation signal V_{COMP-DC} decreases. As shown in FIG. 8, when the stable compensation signal V_{COMP-DC} is between the reference voltages V_{REF1} and V_{REF5}, it is assumed that the upper arm on-time T_{ON_GH} has a first rate of change with respect to the stable compensation signal V_{COMP-DC}. When operating in CRM1, it is assumed that the upper arm on-time T_{ON_GH} has a second rate of change with respect to the stable compensation signal V_{COMP-DC}. FIG. 8 clearly shows that the first rate of change is greater than the second rate of change.

FIG. 12 illustrates the upper arm controller 128D and the lower arm controller 120D that can be used in FIG. 9. Many devices or components in the upper arm controller 128D and the lower arm controller 120D are similar or identical to those previously described for the upper arm controller and the lower arm controller, and can be understood by referring to the previous descriptions, which may not be repeated here.

The delay 223D is used to delay the control signal GL by the delay time T_{DL} before sending it to the counter 214 as a clock signal. The delay time T_{DL} is controlled by the stable compensation signal V_{COMP-DC}.

Simply put, the lower arm controller 120D starts the lower arm on-time T_{ON_GL} when the switch voltage V_{DSL} of the lower arm switch SL is approximately 0V, allowing the lower arm switch SL to achieve ZVS. After the lower arm switch SL has been on for the delay time T_{DL}, the upper arm controller 128D adjusts the length of the upper arm on-time T_{ON_GH} based on whether the current detection signal VCS is approximately 0V. Therefore, theoretically, in a stable state, the length of the upper arm on-time T_{ON_GH} is just enough to make the current detection signal VCS equal to CV when the lower arm switch SL has been on for the delay time T_{DL}.

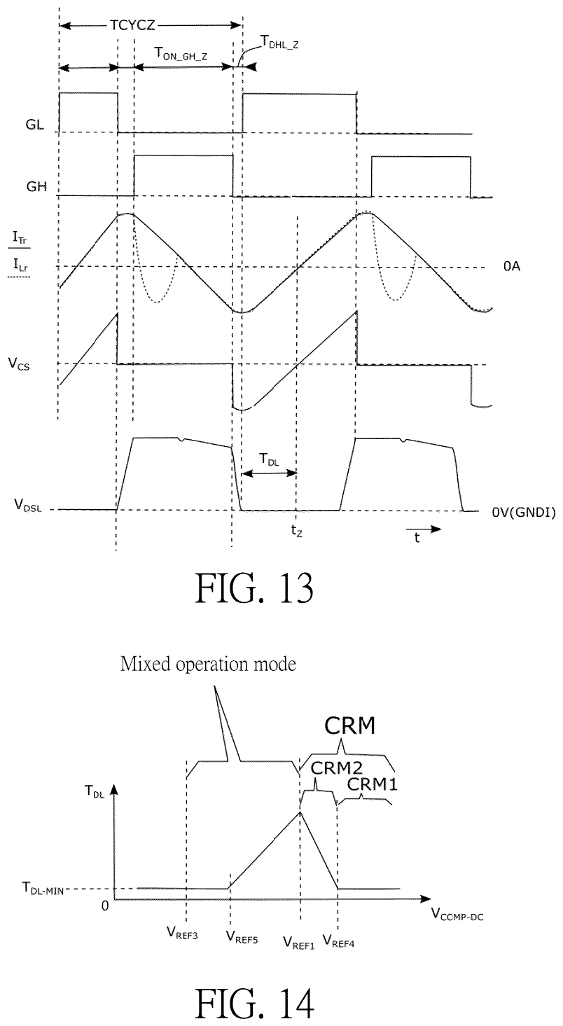

FIG. 13 shows the switching cycle TCYC_{Z} that may be generated by the AHB power supply 100 under the control of the upper arm controller 128D and the lower arm controller 120D. As previously mentioned, the lower arm on-time T_{ON_GL} starts when the switch voltage V_{DSL} is approximately 0V, allowing the lower arm switch SL to achieve ZVS. The length of the upper arm on-time T_{ON_GH} ensures that at time t_{Z}, after the lower arm switch SL has been on for the delay time T_{DL}, the current detection signal VCS is approximately 0V. FIG. 13 is similar to FIG. 10B, with the main difference being that in FIG. 13, the lower arm on-time T_{ON_GL} starts earlier when the switch voltage V_{DSL} is approximately 0V. Comparing FIG. 13 with FIG. 10B also shows that the signal waveforms in FIG. 13 are more energy-efficient because there is no debounce time T_{DEB} within the dead time T_{DHL_Y} in FIG. 10B, during which the body diode of the lower arm switch SL would conduct and consume significant energy.

FIG. 14 shows the relationship between the delay time T_{DL} and the stable compensation signal V_{COMP-DC} in FIG. 12. FIG. 14 is similar to FIG. 11, except that the vertical axis is changed from the debounce time T_{DEB} to the delay time T_{DL}. In some embodiments, the minimum delay time T_{DL_MIN} in FIG. 14 can be 0s, while in other embodiments, the minimum delay time T_{DL_MIN} is a constant greater than 0s. In one embodiment, the relationship between the delay time T_{DL} and the stable compensation signal V_{COMP-DC} in FIG. 14, as well as the upper arm controller 128D and the lower arm controller 120D in FIG. 12, can also result in the AHB power supply 100 producing the results shown in FIG. 8.

Embodiment 1: A control method for a switch-mode power supply, wherein the switch-mode power supply is used to provide an output voltage. The switch-mode power supply includes an inductor and a power switch, wherein the power switch is used to control the current flowing through the inductor. The control method includes:
providing a compensation signal, wherein the compensation signal is controlled by the output voltage;
providing a stable compensation signal based on the compensation signal, wherein the stable compensation signal follows the compensation signal and changes more slowly than the compensation signal. The stable compensation signal is the low-frequency component of the compensation signal;
providing a mixed operation mode, wherein the switch-mode power supply alternates between a switching operation period and an skip period. During the switching operation period, the power switch is turned on at least once, and during the skip period, the power switch remains off; and
based on the difference between the compensation signal and the stable compensation signal, ending one of the switching operation period and the skip period, and starting the other of the switching operation period and the skip period.

Thus, in the mixed operation mode, the switch-mode power supply alternates between a switching operation period and an skip period. During the switching operation period, the power switch is turned on at least once, and during the skip period, the power switch remains off. By comparing the compensation signal controlled by the output voltage and the stable compensation signal, which is the low-frequency component of the compensation signal, the ending and starting of the switching operation period and the skip period are determined. Since the difference between the compensation signal and the stable compensation signal can more accurately reflect the transient changes in the output voltage, the switching operation period and the skip period can be timely adjusted based on the difference between the compensation signal and the stable compensation signal when the output voltage changes due to sudden load changes. This makes the changes in the output voltage smoother (i.e., reduces the output voltage ripple), effectively reducing the potential sudden changes in the output voltage during the process of the load changing from medium to heavy or from medium to light, thereby reducing the harm to the load.

Embodiment 2: The control method as described in Embodiment 1, wherein: when the switch-mode power supply operates in the switching operation period, if the compensation signal is lower than the stable compensation signal and the absolute value of the difference between the compensation signal and the stable compensation signal reaches a predetermined value, the switching operation period is ended, and the skip period is started.

Embodiment 3: The control method as described in Embodiment 1 or 2, wherein: when the switch-mode power supply operates in the skip period, if the compensation signal is higher than the stable compensation signal and the difference between the compensation signal and the stable compensation signal reaches a predetermined value, the skip period is ended, and the switching operation period is started.

Embodiment 4: The control method as described in any one of Embodiments 1 to 3, wherein the switch-mode power supply is an asymmetric half-bridge power supply having a half-bridge, which comprises a first arm switch and a second arm switch. The power switch is the first arm switch, and during the switching operation period, both the first arm switch and the second arm switch are turned on at least once.

Embodiment 5: The control method as described in any one of Embodiments 1 to 4, wherein providing the stable compensation signal based on the compensation signal includes: low-pass filtering the compensation signal to generate the stable compensation signal.

Embodiment 6: The control method as described in any one of Embodiments 1 to 4, wherein providing the stable compensation signal based on the compensation signal includes: periodically sampling the compensation signal to generate the stable compensation signal.

Embodiment 7: The control method as described in any one of Embodiments 1 to 6, further comprising:
calculating the number of switching cycles of the power switch during the switching operation period;
comparing the number with a preset maximum number; and
ending the switching operation period and starting the skip period when the number equals the maximum number.

Embodiment 8: The control method as described in Embodiment 7, further comprising:
providing the maximum number based on the stable compensation signal.

Embodiment 9: The control method as described in any one of Embodiments 1 to 6, further comprising:
comparing the skip period with a maximum skip period; and ending the skip period and starting the switching operation period
when the skip period equals the maximum skip period.

Embodiment 10: The control method as described in Embodiment 9, further comprising:
providing the maximum skip period based on the stable compensation signal.

Embodiment 11: A power controller suitable for a switch-mode power supply, wherein the switch-mode power supply is used to provide an output voltage. The switch-mode power supply includes an inductor and a power switch, wherein the power switch is used to control the current flowing through the inductor. In a mixed operation mode, the switch-mode power supply alternates between a switching operation period and an skip period. During the switching operation period, the power switch is turned on at least once. The power controller comprises:
a signal generator for providing a stable compensation signal based on the compensation signal, wherein the compensation signal is controlled by the output voltage. The stable compensation signal follows the compensation signal and changes more slowly than the compensation signal. The stable compensation signal is the low-frequency component of the compensation signal; and
a skip time generator for ending one of the switching operation period and the skip period and starting the other based on the difference between the compensation signal and the stable compensation signal.

Embodiment 12: The power controller as described in Embodiment 11, wherein the switch-mode power supply is an asymmetric half-bridge power supply having a half-bridge, which comprises a first arm switch and a second arm switch. The power switch is the first arm switch, and during the switching operation period, both the first arm switch and the second arm switch are turned on at least once.

Embodiment 13: The power controller as described in Embodiment 11 or 12, wherein the signal generator is a low-pass filter.

Embodiment 14: The power controller as described in Embodiment 11 or 12, wherein the signal generator is used to periodically sample the compensation signal to generate the stable compensation signal.

Embodiment 15: The power controller as described in any one of Embodiments 11 to 14, further comprising a counter for performing the following steps:
calculating the number of switching cycles of the power switch during the switching operation period;
comparing the number with the maximum number; and
ending the switching operation period and starting the skip period when the number and the maximum number meet preset conditions.

Embodiment 16: The power controller as described in Embodiment 15, wherein the maximum number is generated based on the stable compensation signal.

Embodiment 17: The power controller as described in any one of Embodiments 11 to 16, wherein the skip time generator is used to perform the following steps:
comparing the skip period with the maximum skip period; and
ending the skip period and starting the switching operation period when the skip period equals the maximum skip period.

Embodiment 18: The power controller as described in Embodiment 17, wherein the skip time generator is used to provide the maximum skip period based on the stable compensation signal.

Embodiment 19: A control method for an asymmetric half-bridge power supply, wherein the asymmetric half-bridge power supply includes a half-bridge, which comprises a charging switch and a resonant switch. The charging switch and the resonant switch are used to control a resonant circuit, which includes a transformer and an oscillating capacitor. The asymmetric half-bridge power supply is used to provide an output voltage and supply power to a load. The control method includes:
providing a compensation signal based on the output voltage;
turning on the charging switch for a charging switch on-time;
turning on the resonant switch for a resonant switch on-time; and
adjusting the resonant switch on-time based on the compensation signal, so that the resonant switch on-time increases as the load decreases.

Thus, by adjusting the resonant switch on-time to increase as the load decreases, the length of at least one switching cycle is extended during the process of the load changing from heavy to medium. This results in less energy being transferred to the output voltage per unit time, reducing the switching frequency and the associated losses. It also allows the power supply to operate in critical mode under medium load conditions without needing to activate the ignore time, reducing the ripple of the output voltage and making the changes in the output voltage smoother when the load suddenly changes, thereby reducing the harm to the load.

Embodiment 20: The control method as described in Embodiment 19, further comprising:
providing a current detection signal representing the inductive current flowing through the transformer, wherein the charging switch on-time ends when the current detection signal reaches the signal peak value; and
ensuring that the signal peak value does not change with the load when the resonant switch on-time increases as the load decreases.

Embodiment 21: The control method as described in Embodiment 19 or 20, further comprising:
detecting whether the charging switch meets the predetermined condition for being capable of performing ZVS when the resonant switch is off, and providing a comparison result; and
controlling the length of the resonant switch on-time bases on the comparison result remains at a first logic value for a debounce time.

Embodiment 22: The control method as described in Embodiment 21, further comprising:
controlling the debounce time based on the stable compensation signal, wherein the stable compensation signal is the low-frequency component of the compensation signal.

Embodiment 23: The control method as described in Embodiment 22, further comprising:
detecting whether the charging switch meets the predetermined condition for being capable of performing ZVS when the resonant switch is off, to provide a trigger signal;
triggering the leading edge of the charging switch on-time based on the trigger signal;
delaying the leading edge of the charging switch on-time by a delay time after the logical change of the trigger signal; and
controlling the delay time based on the stable compensation signal.

Embodiment 24: The control method as described in Embodiment 23, wherein the debounce time equals the delay time.

Embodiment 25: The control method as described in any one of Embodiments 19 to 24, further comprising:
providing a current detection signal representing the inductive current flowing through the transformer; and
detecting whether the current detection signal meets the predetermined condition within a delay time after the start of the charging switch on-time, to provide a comparison result;
adjusting the length of the resonant switch on-time based on the comparison result; and
providing the delay time based on the stable compensation signal.

Embodiment 26: The control method as described in Embodiment 25, further comprising:
detecting whether the charging switch is in a state to achieve ZVS when the resonant switch is off, to provide a trigger signal; and
triggering the leading edge of the charging switch on-time based on the trigger signal.

Embodiment 27: A power controller suitable for an asymmetric half-bridge power supply, wherein the asymmetric half-bridge power supply includes a half-bridge, which comprises a charging switch and a resonant switch. The charging switch and the resonant switch are used to control a resonant circuit, which includes a transformer and an oscillating capacitor. The power controller comprises:
a charging switch controller for turning on the charging switch for a charging switch on-time based on a compensation signal, wherein the compensation signal is controlled by the output voltage of the asymmetric half-bridge power supply, which supplies power to a load; and
a resonant switch controller for turning on the resonant switch for a resonant switch on-time based on the compensation signal;
wherein the charging switch controller is used to adjust the resonant switch on-time so that the resonant switch on-time increases as the load decreases.

Embodiment 28: The power controller as described in Embodiment 27, wherein the current detection signal represents the inductive current flowing through the transformer, and the charging switch on-time ends when the current detection signal reaches the signal peak value;
the charging switch controller is used to ensure that the signal peak value does not change with the load when the resonant switch on-time increases as the load decreases.

Embodiment 29: The power controller as described in Embodiment 27 or 28, wherein the charging switch controller comprises:
a comparator for comparing a detection signal and a preset signal to provide a trigger signal, wherein the detection signal represents the switch voltage of the charging switch;
an on-time controller for starting the charging switch on-time based on the trigger signal; and
a delay connected between the comparator and the on-time controller for transmitting the trigger signal to the on-time controller after a delay time;
wherein the delay determines the delay time based on the stable compensation signal, which is the low-frequency component of the compensation signal.

Embodiment 30: The power controller as described in any one of Embodiments 27 to 29, wherein the resonant switch controller is used to control the resonant switch on-time based on the detection signal that appears when both the charging switch and the resonant switch are off, and the detection signal represents the switch voltage of the charging switch.

Embodiment 31: The power controller as described in any one of Embodiments 27 to 30, wherein the resonant switch controller comprises:
a comparator for comparing a detection signal and a preset signal to provide a comparison result, wherein the detection signal represents the switch voltage of the charging switch;
a counter for changing the count based on the comparison result;
a digital-to-analog converter for providing an analog reference bit based on the count;
an on-time controller for determining the resonant switch on-time based on the analog reference bit; and
a debounce circuit connected between the comparator and the counter for transmitting the comparison result to the counter after the comparison result remains at a first logic value for a debounce time;
wherein the debounce circuit determines the debounce time based on the stable compensation signal, which is the low-frequency component of the compensation signal.

Embodiment 32: The power controller as described in any one of Embodiments 27 to 31, wherein the resonant switch controller is used to control the resonant switch on-time based on the current detection signal that appears during the charging switch on-time.

Embodiment 33: The power controller as described in Embodiment 32, wherein the resonant switch controller comprises:
a comparator for comparing the current detection signal and a preset signal to provide a comparison result;
a counter for changing the count based on the comparison result generated after a delay time following the start of the charging switch on-time;
a digital-to-analog converter for providing an analog reference bit based on the count; and
an on-time controller for determining the resonant switch on-time based on the analog reference bit;
wherein the delay time is generated based on the stable compensation signal, which is the low-frequency component of the compensation signal.

Embodiment 34: The power controller as described in Embodiment 33, wherein the charging switch controller is used to provide a control signal for controlling the charging switch;
the counter is used to change the count using the control signal as a clock signal;
the resonant switch controller further comprises a delay for providing the delay time based on the stable compensation signal to delay the control signal.

Embodiment 35: A switch-mode power supply comprising: the power controller as described in any one of Embodiments 11 to 18.

Embodiment 36: An asymmetric half-bridge power supply comprising: the power controller as described in any one of Embodiments 27 to 34.

The above descriptions are merely preferred embodiments of the present invention. Any equivalent changes and modifications made according to the scope of the patent application of the present invention should be covered by the scope of the present invention.

It should be understood that the embodiments of the present invention can be combined. For example, the control method described in any one of Embodiments 19 to 26 can be used under heavy load conditions, and the control method described in any one of Embodiments 1 to 10 can be used when the load decreases (e.g., under medium load conditions).

The embodiments of the present invention have been described in detail. To avoid obscuring the concept of the present invention, some well-known details in the field have not been described. Those skilled in the art can fully understand how to implement the disclosed technical solutions based on the above descriptions.

Although some specific embodiments of the present invention have been described in detail through examples, those skilled in the art should understand that the above examples are for illustration purposes only and are not intended to limit the scope of the present invention. Those skilled in the art should understand that modifications or equivalent replacements of some technical features can be made to the above embodiments without departing from the scope and spirit of the present invention. The scope of the present invention is defined by the appended claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method for a switch-mode power supply, the switch-mode power supply being used to provide an output voltage, the switch-mode power supply comprising an inductor and a power switch, the power switch being used to control a current flowing through the inductor, the control method comprising:
providing a compensation signal, the compensation signal being controlled by the output voltage;
providing a stable compensation signal based on the compensation signal, the stable compensation signal being a low-frequency component of the compensation signal;
providing a mixed operation mode, wherein in the mixed operation mode, the switch-mode power supply operates alternately between a switching operation period and a skip period, wherein during the switching operation period, the power switch is turned on at least once, and during the skip period, the power switch remains off; and
ending one of the switching operation period and the skip period and starting the other based on a difference between the compensation signal and the stable compensation signal.

2. The control method of claim 1, wherein:
when the switch-mode power supply operates in the switching operation period, if the compensation signal is lower than the stable compensation signal and an absolute value of the difference between the compensation signal and the stable compensation signal reaches a predetermined value, the switching operation period is ended, and the skip period is started.

3. The control method of claim 1, wherein:
when the switch-mode power supply operates in the skip period, if the compensation signal is higher than the stable compensation signal and the difference between the compensation signal and the stable compensation signal reaches a predetermined value, the skip period is ended, and the switching operation period is started.

4. The control method of claim 1, wherein the switch-mode power supply is an asymmetrical half-bridge power supply, the asymmetrical half-bridge power supply having a first arm switch and a second arm switch forming a half-bridge, the power switch being the first arm switch, and during the switching operation period, both the first arm switch and the second arm switch are turned on at least once.

5. The control method of claim 1, wherein providing the stable compensation signal based on the compensation signal comprises:
low-pass filtering the compensation signal to generate the stable compensation signal.

6. The control method of claim 1, wherein providing the stable compensation signal based on the compensation signal comprises:
periodically sampling the compensation signal to generate the stable compensation signal.

7. The control method of claim 1, further comprising:
calculating a number of switching cycles of the power switch during the switching operation period;
comparing the number with a maximum number; and
when the number equals the maximum number, ending the switching operation period and starting the skip period.

8. The control method of claim 7, further comprising:
providing the maximum number based on the stable compensation signal.

9. The control method of claim 1, further comprising:
comparing the skip period with a maximum skip period; and
when the skip period equals the maximum skip period, ending the skip period and starting the switching operation period.

10. The control method of claim 9, further comprising:
providing the maximum skip period based on the stable compensation signal.

11. A power controller, suitable for a switch-mode power supply, the switch-mode power supply being used to provide an output voltage, the switch-mode power supply comprising an inductor and a power switch, the power switch being used to control a current flowing through the inductor, in a mixed operation mode, the switch-mode power supply operates alternately between a switching operation period and a skip period, wherein during the switching operation period, the power switch is turned on at least once, and during the skip period, the power switch remains off, the power controller comprising:
a signal generator, configured to provide a stable compensation signal based on a compensation signal, wherein the compensation signal is controlled by the output voltage, and the stable compensation signal is a low-frequency component of the compensation signal; and
a skip time generator, configured to end one of the switching operation period and the skip period and start the other based on a difference between the compensation signal and the stable compensation signal.

12. The power controller of claim 11, wherein the switch-mode power supply is an asymmetrical half-bridge power supply, the asymmetrical half-bridge power supply having a first arm switch and a second arm switch forming a half-bridge, the power switch being the first arm switch, and during the switching operation period, both the first arm switch and the second arm switch are turned on at least once.

13. The power controller of claim 11, wherein the signal generator is a low-pass filter.

14. The power controller of claim 11, wherein the signal generator is used to periodically sample the compensation signal to generate the stable compensation signal.

15. The power controller of claim 11, further comprising a counter, the counter being used to perform the following steps:
calculating a number of switching cycles of the power switch during the switching operation period;
comparing the number with a maximum number; and
when the number and the maximum number reach a preset condition, causing the skip time generator to end the switching operation period and start the skip period.

16. The power controller of claim 15, wherein the maximum number is generated based on the stable compensation signal.

17. The power controller of claim 11, wherein the skip time generator is used to perform the following steps:
comparing the skip period with a maximum skip period; and
when the skip period equals the maximum skip period, ending the skip period and starting the switching operation period.

18. The power controller of claim 17, wherein the skip time generator is used to provide the maximum skip period based on the stable compensation signal.
